(19) United States
(12) Patent Application Publication
(10) Pub. No.: US 2012/0234039 A1
(43) Pub. Date: Sep. 20, 2012

(54) Method for maximizing availability of heat exchangers for removal of volatile vapors from a storage vessel

(76) Inventor: Henry T. Hilliard, JR., Houston, TX (US)

(21) Appl. No.: 13/385,382

(22) Filed: Feb. 16, 2012

Related U.S. Application Data
(63) Continuation of application No. 11/677,425, filed on Feb. 21, 2007, now abandoned.
Application No. 11/677,425 is a continuation-in-part of application No. 11/092,466, filed on Mar. 29, 2005, now Pat. No. 7,343,759.

(51) Int. Cl. B01D 9/04

(52) U.S. Cl. 62/532

(57) ABSTRACT

A method of recovering hydrocarbons from a storage vessel by utilizing two or more heat exchangers is disclosed. A stream of vapors from the vessel is directed first through a first heat exchanger and then through a second heat exchanger where a portion of the vapors is condensed. The pressure drop between either the inlet of the first heat exchanger or the inlet of the second heat exchanger and the outlet of the second heat exchanger is monitored to detect frozen condensate in the second heat exchanger. When the pressure drop increases to a level requiring remediation, the pressure drop is remediated by redirecting a relatively warm portion of the stream to a portion of the second heat exchanger containing the frozen condensate to melt the frozen condensate.

### STATEMENT OF RELATED APPLICATIONS

This application is a continuation of U.S. application Ser. No. 11/677,425 filed Feb. 21, 2007, now U.S. Publication 20070151290, which is a continuation-in-part of U.S. application Ser. No. 11/092,466 filed Mar. 29, 2005, now U.S. Publication 20060218966.

### BACKGROUND OF THE INVENTION

1. Field of the Invention

This invention relates purging tanks and vessels, and more particularly, to methods using heat exchangers to efficiently remove and recover volatile materials entrained within vapors residing in tanks and vessels.

2. Description of the Related Art

Volatile liquids used in chemical and energy sectors are transported in pipes and stored in tanks and vessels at bulk terminals, production and processing facilities, refineries, distribution and end-user facilities, barges, ships, tank trucks and rail cars, herein collectively referred to as vessels. While resident in vessels, volatilization produces vapors that are often displaced from the vessel to accommodate liquid or removed for maintenance or other operations.

Vapors may be purged by filling a vessel with water, or other liquids, or vapors may be purged using steam or inert gas to entrain or displace the vapors from the vessel. Volatile materials recovered as liquid are available for recycle or sale, but the efficient recovery is required to justify the cost of equipment necessary for cooling the vapor stream and recovering the liquids. Heat exchangers may be used to cool and condense volatile materials, and lower temperatures result in better condensation and recover. But substantial variations in vapor stream composition and changing freezing points can result in freezing of condensate and plugging of the heat exchanger. Blockages from ice make it difficult to continuously and efficiently operate the heat exchangers. As a result, vapors are often released without recovery and emitted to the atmosphere.

What is needed is a method of using and managing the heat exchangers to maximize the recovery of volatile liquids. What is needed is a method for efficiently using and managing heat exchangers for condensing volatile materials subject to varying vapor feed stream compositions. What is needed is a method for maximizing the availability and efficiency of heat exchangers by sensing and automatically correcting for heat exchanger flow problems, such as plugging.

### SUMMARY OF THE INVENTION

The present invention satisfies the above-mentioned needs and others. The present invention provides a method for efficiently removing volatile vapors from a vessel using two or more heat exchangers to condense and then freeze at least some of the vapor stream, to sense the freezing within at least one heat exchanger, and to redirect the flow path of the vapor stream to remediate the freezing and restore efficient heat exchanger operation. In one embodiment, the present invention provides a method of maintaining maximum efficiency and availability of heat exchangers for use in condensing and recovering volatile materials from a vessel by monitoring heat exchanger pressure drops, detecting freezing within the heat exchanger, and automatically actuating one or more valves to redirect the flow path of the vapor stream through the heat exchangers and thereby remediate a blockage.

In a preferred embodiment, the method includes the steps of establishing a flow of a vapor stream containing volatile materials from a vessel through a first heat exchanger and then through a second heat exchanger, condensing at least a portion of the volatile material within the vapor stream, freezing at least a portion of the condensate formed in the second heat exchanger to generate an increased pressure drop between the stream entrance to either the first or second heat exchanger and the discharge of the second heat exchanger, sensing when the pressure drop exceeds a predetermined set point, and redirecting the flow path of the vapor stream to pass a relatively warm portion of the vapor stream through the segment of the second heat exchanger to melt the blockage.

The vapor stream may be redirected through the first and second heat exchangers by reversing the flow through the first or the second heat exchangers, or both and also by juxtaposing the flow path sequence of the first and second heat exchangers. The blockage caused by the frozen condensate will be rapidly and controllably melted by heat in the redirected vapor stream, and the resulting condensate may be recovered.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a high-level flowchart illustrating one embodiment of the method of the present invention.

FIG. 2A is a schematic showing the flow path of a vapor stream from a vessel through a first and a second heat exchanger to condense and recover volatile materials.

FIG. 2B is a schematic showing the redirected flow path of a vapor stream from a vessel through a first and a second heat exchanger to condense and recover volatile materials. The positions of the heat exchangers are juxtaposed from the flow path in shown in FIG. 2A to melt a blockage in the downstream portion of the second heat exchanger.

FIG. 2C is a schematic showing the redirected flow path of a vapor stream from a vessel through a first and second heat exchanger. The direction of the flow path through the first and second heat exchanger is reversed from the flow path shown in FIG. 2A to melt a blockage in the downstream portion of the second heat exchanger.

### DETAILED DESCRIPTION OF THE PREFERRED EMBODIMENT

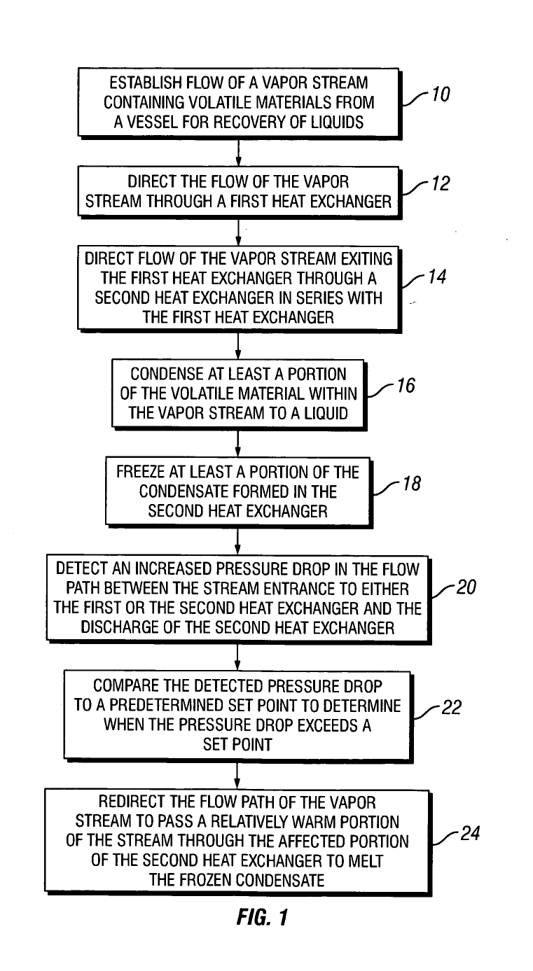

FIG. 1 is a flowchart illustrating one embodiment of the method of the present invention. In step 10, a flow of a vapor stream containing volatile materials from a vessel is established for recovery of liquids and, in step 12, the flow of the vapor stream is directed through a first heat exchanger and then, in step 14, the flow of the vapor stream is directed through a second heat exchanger arranged in series with the first heat exchanger. In step 16, at least a portion of the volatile material within the vapor stream is condensed to a liquid and, in step 18, at least a portion of the condensate formed is frozen in the second heat exchanger. In step 20, the increased pressure drop across between the stream entrance to either the first or second heat exchanger and the discharge of the second heat exchanger is detected, and in step 22, the detected pressure drop is compared to a predetermined set point to determine when the pressure drop exceeds the set point. In step 24, the flow path of the vapor stream is redirected to pass a relatively warmer portion of the vapor stream through the portion of the second heat exchanger to melt the blockage caused from the freezing of at least a portion of the condensate.

The remedial action in step 24 may be customized based either on the set point or on the difference between the detected pressure drop and the set point. The remedial action in step 24 may be to reverse the direction of flow of the vapor stream through the first and second heat exchangers so that the flow stream first enters the set of two heat exchangers at what was previously the discharge of the second heat exchanger and discharges from the set of two heat exchangers at what was previously the inlet to the first heat exchanger.

In an alternate embodiment of the method of the present invention, the remedial action in step 24 may be to juxtapose the sequence of the first and second heat exchangers to redirect the flow path of the vapor stream to first pass through what was the second heat exchanger, and then subsequently to pass through what was previously the first exchanger. In this alternate embodiment of the present invention, the flow path of the vapor stream still passes through each heat exchanger in the same direction as in the original arrangement, but the sequence of the heat exchangers one relative to the other is reversed.

In still another embodiment of the method of the present invention, the remedial action in step 24 may be to both reverse the direction of flow of the vapor stream through each of the heat exchangers and also to juxtapose the sequence of what were the first heat exchanger and the second heat exchanger.

Upon taking of one or more of these remedial measures, the blockage resulting from the frozen condensate is melted and the method returns to step 16 to monitor the pressure drop through the now-first, the now-second, or both the now-first and now-second heat exchangers in the same manner as discussed above. The method continues in this loop defined by steps 16 through 24 until flow of the vapor stream terminates.

The heat exchangers used in implementing the method of the present invention may be concurrent (parallel) or countercurrent heat exchangers, but are preferably countercurrent heat exchangers. The heat exchangers of the present invention may be shell and tube heat exchangers having a refrigerant or a cooling agent passed on one side of the heat exchanger opposite the flow stream of the vapor. Alternately, a plate heat exchanger, a heat storage heat exchanger or any other type of heat exchanger that can receive and discharge a flow stream and accommodate the formation of condensate and the freezing of at least a portion of the condensate within one pass of the heat exchanger may be used.

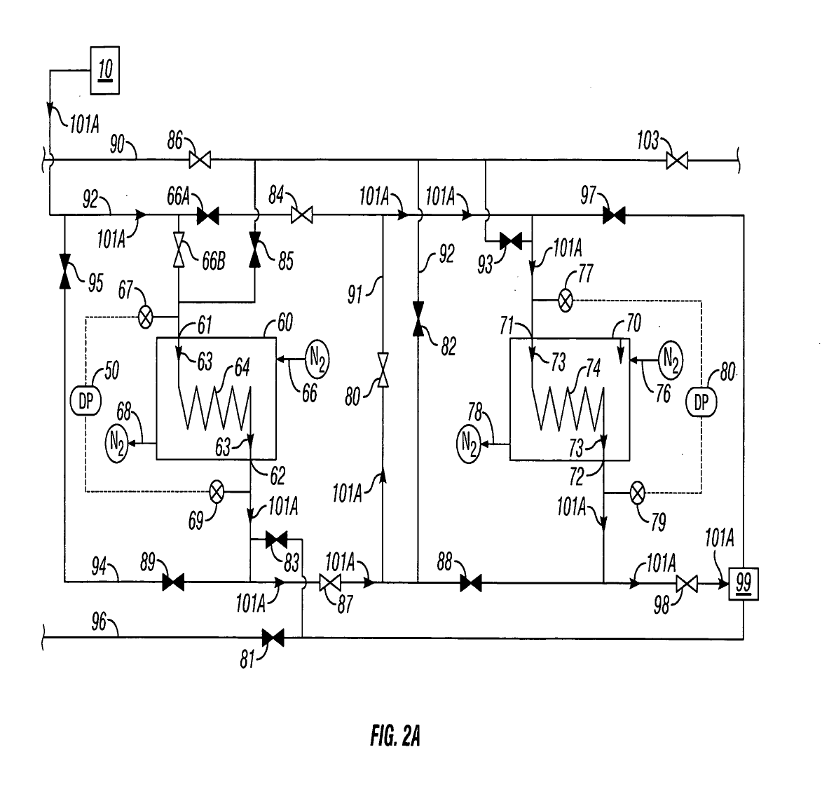

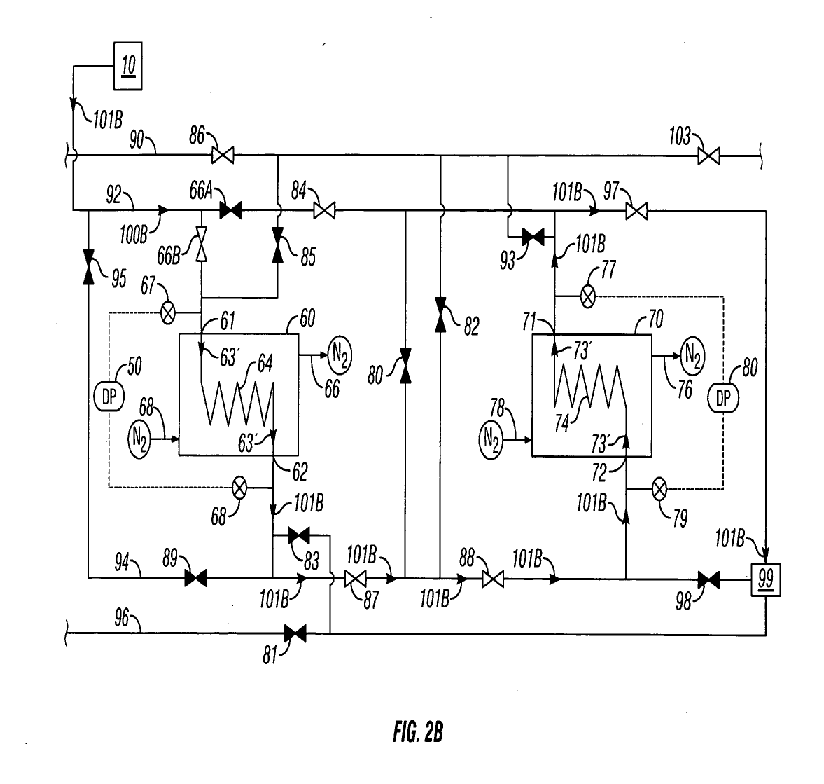

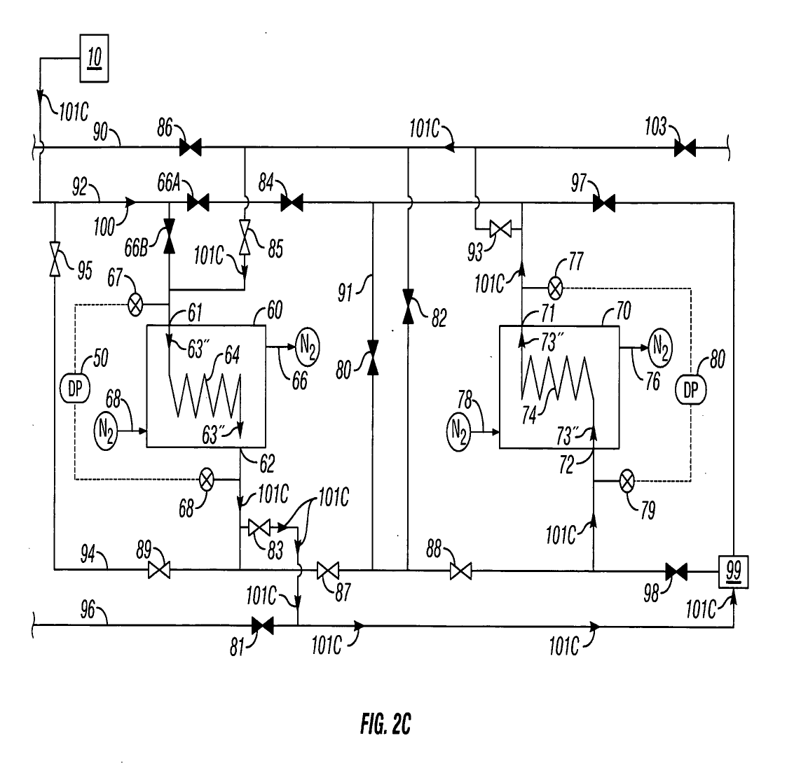

FIGS. 2A-2C is a vapor stream flowing from a vessel 10 to a series of schematics illustrating one embodiment of the method of the present invention. FIG. 2A shows a first heat exchanger 60, comprising a first inlet/outlet 61, a second inlet/outlet 62 in fluid communication with the first inlet/outlet 61, and a first length of tubing 64 where cooling of the vapor stream occurs between the first inlet/outlet 61 and the second inlet/outlet 62. The first heat exchanger 60 further comprises a coolant entrance 66 in fluid communication with a coolant exit 68 for a coolant flow on the side (pass) of the heat exchanger opposite the vapor stream for removing heat from the vapor stream. Warming of the coolant flow on this opposite pass occurs between the coolant entrance 36 and coolant exit 68 in the first heat exchanger, and the coolant discharged at outlet 68 may be recycled for cooling, condensation and/or compression, or it may be routed to one or more additional heat exchangers for further cooling of the vapor stream.

FIG. 2A shows a second heat exchanger 70 for receiving and further cooling the vapor stream discharged from the second inlet/outlet 62 of the first heat exchanger 60, the second heat exchanger comprising a first inlet/outlet 71, a second inlet/outlet 72, and a second tubing 74 where further cooling of the vapor stream occurs between the first inlet/outlet 71 and the second inlet/outlet 72. The second heat exchanger 70 further comprises a coolant entrance 76 in fluid communication with a coolant exit 78 for a coolant flow on the side (pass) of the second heat exchanger opposite the vapor stream for further removing heat from the vapor stream. Warming of the coolant flow on this opposite side occurs between the entrance 76 and exit 78 in the second heat exchanger and the discharged coolant at exit 78 may be recycled for cooling, condensation and/or compression, or it may be routed to one or more additional heat exchangers for further cooling of the vapor stream.

FIG. 2A further shows arrows 63 indicating an initial flow path of a vapor stream flowing from a vessel 10 to a the first heat exchanger 60 and arrows 73 indicating the initial flow path of the vapor stream through the second heat exchanger 70. Vapor stream entering the process at pipe location 92 in direction shown by arrows 101A is diverted by closed valve 66A and closed valve 85 through open valve 66B and into the first inlet/outlet 61 of first heat exchanger 60. The vapor stream flows through the tubing 64 where it is cooled and the cooled vapor stream is discharged from the first heat exchanger 60 the second at inlet/outlet 62. Valves 89, 88, 82 and 97 are closed to divert the vapor stream through open valves 87 and 80 to the first inlet/outlet 71 of the second heat exchanger 70 cooled vapor stream discharged from the second inlet/outlet 72 of the second heat exchanger 70 is directed as shown by arrows 101A through open valve 98 to additional heat exchangers or to condensate recovery vessels 99.

The first heat exchanger 60 and the second heat exchanger 70 operate in series as described above to progressively cool the vapor stream and to form a condensate of at least a portion of the volatile materials contained within the vapor stream. The pressure of the vapor stream at various locations along the vapor stream flow path may be monitored to detect plugging caused by freezing of condensate. For example, the pressure of the vapor stream may be monitored at or near the inlet/outlets 61, 62, 71, 72 to detect plugging resulting from the freezing of condensate. In FIG. 2A, the pressure drop across the first heat exchanger 60 may be determined by comparing the sensed pressures obtained using first pressure sensor 67 and second pressure sensor 69 at the first inlet/outlet 61 and the second inlet/outlet 62, respectively. The pressure drop across the second heat exchanger 70 may be determined by comparing the sensed pressures obtained using third pressure sensor 77 and fourth pressure sensor 79 at the first inlet/outlet 71 and the second inlet/outlet 72, respectively. The pressure drops across the first heat exchanger 60 and the second heat exchanger 70 may be monitored in first differential pressure monitor 50 and second differential pressure monitor 80, respectively.

As indicated by the arrows 63 and 73 of FIG. 2A, the vapor stream is cooled by the first heat exchanger 60, and then enters the second heat exchanger 70 for further cooling. As a result, the most probable location for condensate to freeze and plug the tubing 64 or 74 is in tubing 74 within the second heat exchanger 70. A plug within the tubing 74 within the second heat exchanger 70 may be detected by an increased differential pressure at differential pressure monitor 80 that compares the pressures at the first inlet/outlet 71 and the second inlet/outlet 72. If the sensed pressure differential exceeds a set point, remedial action may be taken to redirect the flow path of the vapor stream as shown in either of FIG. 2B or 2C.

FIG. 2B shows the first heat exchanger 60 and the second heat exchanger 70 of FIG. 2A after the flow path of the vapor stream is redirected to remediate the plugging of the tubing 74 caused by freezing at least a portion of the condensate from the vapor stream originating from the vessel (not shown). Upon sensing an increased pressure drop across the first inlet/outlet 71 and the second inlet/outlet 72 of the second heat exchanger 70, valves may be manually or automatically operated to redirect the flow path and to direct a generally warmer portion of the vapor stream to the affected portion in the tubing 74. FIG. 2B illustrates the flow path of the vapor stream that enters the first heat exchanger 60 through the first inlet/outlet 61, flows through tubing 64 within the first heat exchanger 60 and is cooled by the flow of coolant through the opposite side of first heat exchanger 60. The vapor stream is discharged from the first heat exchanger 60 through the second inlet/outlet 62 and is directed through piping and valves to enter second heat exchanger 70 through the second inlet/outlet 72. The vapor stream flows through the tubing 74 within second heat exchanger 70 and is further cooled by the flow of coolant through the opposite side of the second heat exchanger 70. The cooled vapor stream exits the second heat exchanger 70 through the first inlet/outlet 71 and is routed to other heat exchangers or to condensate recovery equipment 99, such as tanks, filters, process equipment or pumps.

The redirected flow path of the vapor stream illustrated in FIG. 2B is indicated by arrows 101B and by the arrows 63′ in the first heat exchanger 60 and by arrows 73′ in second heat exchanger 70. If the blockage resulting from the condensate frozen using the flow path shown in FIG. 2A occurs nearer the second inlet/outlet 72 than the first inlet/outlet 71, redirection of the flow path as shown in FIG. 2B introduces a relatively warm portion of the vapor stream discharged from the second inlet/outlet 62 of the first heat exchanger 60 into the affected portion of the second heat exchanger 70. The higher specific heat content in the vapor stream from the redirected warm segment into the second inlet/outlet 72 melts the frozen condensate for recovery as a liquid, and efficient operation of the heat exchangers 60, 70 at a favorably low temperature profile continues. The redirection of the flow path in FIG. 2A to the flow path shown in FIG. 2B may be manually or automatically achieved by closure of valves 80 and 98, opening valves 88 and 97, to direct condensate to condensate exiting the second heat exchanger 70 at the first inlet/outlet 71 recovery equipment 99, such as tanks, filters, process equipment or pumps.

FIG. 2C illustrates an alternate embodiment of the method of the present invention. The first heat exchanger 60 and second heat exchanger 70 are shown in FIG. 2A after the flow path of the vapor stream has been redirected to remediate a plugging problem caused by freezing at least a portion of the condensate in the vapor stream. The redirected flow path of the vapor stream illustrated in FIG. 2C is indicated by arrows 10C and by arrows 63″ in the first heat exchanger 60 and by arrows 73″ in the second heat exchanger 70. The vapor stream is redirected to first enter the second heat exchanger 70 through the second inlet/outlet 72, the vapor stream is cooled in the tubing 74 and then exits the second heat exchanger 70 through the first inlet/outlet 71. The cooled vapor stream enters the first heat exchanger 60 through the first inlet/outlet 61 and flows through the tubing 64 within the first heat exchanger 60. The vapor exits the first heat exchanger 60 through the second inlet/outlet 62. In FIG. 2C, what was the second and downstream heat exchanger 70 in FIG. 2A becomes, after redirection of the vapor stream, the first and upstream heat exchanger, and what was the first and upstream heat exchanger 60 in FIG. 2A becomes, after redirection of the vapor stream, the second, and downstream heat exchanger. The redirection of the flow path in FIG. 2A to the flow path shown in FIG. 2C may be manually or automatically achieved by closure of valves 80, 103, 86, 98 and 66B, and by opening valves 88, 83, 95, 93, and 85 to direct condensate exiting heat exchanger 60 to condensate recovery equipment 99, such as tanks, filters, process equipment or pumps.

Additional remedial measures may include reducing the flow rate(s) of the coolant or the composition of the coolant, or both, that flows through the first heat exchanger and the second heat exchanger to cool the vapor stream.

The valves may be automatically actuated using a microprocessor to monitor the differential pressure monitors 50 and 80, and using solenoids and any of a variety of valve actuators to open and/or close valves.

While the above embodiments discuss a system utilizing two heat exchangers, it will be apparent to one of ordinary skill in the art that the method of the present invention may be implemented with more than two heat exchangers, or with heat exchangers of different types, including heat exchangers that are cooled by air, water or other materials that can absorb heat from the vapor stream to condense volatile materials. The use of the word “tubing” to describe the structure between the inlet/outlets of each heat exchanger should not be interpreted as limiting, and includes all structures used in heat exchangers to generally confine and route vapor streams including pipes, shells, and the like, and these may not necessarily contain an aligned bore.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. For example, the phrase “a heat exchanger comprising two sides” should be read to describe a heat exchanger having two or more sides. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made in the preferred embodiments of the present invention without departing from its true spirit. The foregoing description is provided for the purpose of illustration only and should not be construed in a limiting sense. Only the language of the following claims should limit the scope of this invention.

What is claimed is:

1. A method of recovering hydrocarbons from a storage vessel comprising:
flowing a stream of vapors from the vessel to a first heat exchanger;
flowing the stream of vapors from the first heat exchanger to a second heat exchanger;
first applying a coolant to the second heat exchanger to cool the stream of vapors and condense at least a portion of the stream of vapors;
forming a frozen condensate in the second heat exchanger;
discontinuing the flow of the coolant to the second heat exchanger;
discontinuing the flow of the stream of vapors from the first heat exchanger to the second heat exchanger;
discontinuing the flow of the stream of vapors from the vessel to the first heat exchanger;
flowing the stream of vapors from the vessel to the second heat exchanger to melt the frozen condensate;
flowing the stream of vapors from the second heat exchanger to the first heat exchanger; and
applying a coolant to the first heat exchanger to cool the stream of vapors flowing from the second heat exchanger to the first heat exchanger and condense at least a portion of the stream of vapors.

2. A method of recovering hydrocarbons from a storage vessel comprising:
flowing a stream of vapors from the vessel;
directing the stream through a first heat exchanger having an inlet and an outlet to cool the vapor stream;
directing the stream through a second heat exchanger having an inlet and an outlet to further cool the stream and condense at least a portion of the vapors;
monitoring the pressure drop between either the inlet of the first heat exchanger or the inlet of the second heat exchanger and the outlet of the second heat exchanger to detect frozen condensate in the second heat exchanger; and
remediating the pressure drop by redirecting a relatively warm portion of the stream to a portion of the second heat exchanger containing the frozen condensate to melt the frozen condensate.

3. The method of claim 2, wherein the step of remediating the pressure drop includes the step of reversing the flow of the stream of vapors through the second heat exchanger.

4. A method of recovering material from a vessel comprising:
flowing a stream of vapors from the vessel;
directing the vapor stream through a first heat exchanger and then though a second heat exchanger in series with the first heat exchanger to condense at least a portion of the vapors;
freezing at least a portion of the condensate in the second heat exchanger;
monitoring the pressure drop across either the second heat exchanger or both the first and second heat exchangers to detect plugging due to frozen condensate; and
remediating the pressure drop by redirecting the path of the vapor stream to flow a relatively warmer portion of the vapor stream to an affected portion of the second heat exchanger containing the frozen condensate.

5. The method of claim 4, wherein remediating the pressure drop across the heat exchanger comprises reversing the flow of the stream of vapors through one or both of the first and second heat exchangers.

6. The method of claim 3, wherein the step of reversing the flow of the stream of vapors through the second heat exchanger includes the steps of diverting the stream of vapors from the vessel to the outlet of the second exchanger.

7. The method of claim 3, further including the step of removing the stream of vapors from the inlet of the second exchanger and flowing it to the inlet of the first exchanger.
